(19) United States
(12) Patent Application Publication
(10) Pub. No.: US 2019/0254484 A1
(43) Pub. Date: Aug. 22, 2019

(54) Bathtub Edge Guard

(71) Applicant: Travis Vollmering, JR., Orange Grove, TX (US)

(72) Inventor: Travis Vollmering, JR., Orange Grove, TX (US)

(21) Appl. No.: 15/900,896

(22) Filed: Feb. 21, 2018

(51) Int. Cl. A47K 3/00

(52) U.S. Cl. CPC A47K 3/001; F16B 47/00

(57) ABSTRACT

The present disclosure describes various implementations of an edge guard that is configured for application along the sidewall edges of tubs, sinks, and the like. A basic implementation comprises a central member, a multitude of arms, and at least one surface fastener. Additional implementations further comprise one or more of the following features: at least one elongated arm, at least one cushion, a connector, and a friction enhancer.

### CROSS-REFERENCE TO RELATED APPLICATIONS

This application does not claim the benefit of a provisional patent application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND

Annually, hundreds of injuries occur when people make unintended forceful contact with hard surfaces. In particular, slips and falls where people fall onto tub and sink edges can be particularly injurious. Sadly, many of these accidents are fatal yet preventable.

Many devices have been developed with the goal of improving safety or reducing the occurrence of the injurious event. For example, there are many non-slip mats or moisture absorbing mats that seek to prevent slips. Other inventions have sought to improve the access to tubs to prevent slips and falls.

Other inventions have addressed the point of impact, generally speaking, by applying an impact absorbing cushion over exposed edges that are likely to be points of contact. See U.S. Pat. Nos. 4,153,230, 5,496,609, 5,639,072, 6,044,601, and 6,682,037. U.S. Pat. Nos. 9,462,886 and 7,114,200 disclose products specific to the edges of sinks, tubs, and pools. Broadly speaking, these have the common feature of using an adhesive means to secure an impact absorbing member onto the target surface. The goal is to reduce injury by absorbing or dissipating the kinetic energy of the impact.

While these solutions have certain advantages, the inventions and products to date suffer from a lack of adaptability. Namely, the prior art lacks the ability to readily configure to the inside, top edge, and outside of curved walls. This is significant problem that has resulted in a low adoption and application rate by the public. It is well known that sinks and tubs are not always generally rectangular. They are often formed with a generally oval shaped perimeter. But sinks and tubs are also known to be made with perimeters having generally irregular shapes. These may come from aesthetic design features or other embellishments. Additionally, the edges and corners themselves may be rounded or meet at angles other than a right angle (ninety degrees). The prior art does not adapt well to the non-rectangular edges and non linear surfaces. This can leave many exposed edges of a tub or sink without the protective impact absorbing covering. For this reason, the prior art has not found success in the market.

### BRIEF SUMMARY

The disclosure of the present invention concerns a bathtub edge guard that offers impact protection and enhanced surface grip in an adaptable form factor.

An objective of the present disclosure is to describe a sink or tub edge covering that is capable of adapting to a wide range of contours seen on the sink or tub to which it is applied. It is a further objective of the disclosure that the covering be capable of readily absorbing kinetic impact energy to reduce injury during collisions. It is another objective that the disclosure describe how the invention is well suited to the environment in which it will be used, by being resistant to water wear, staining, and microbial growth for example.

The disclosure describes how the present invention achieves a superior adaptability in conforming to tub and sink walls and edges by the use of separate arms extending from a flexible elongated central member. The disclosure will show how collectively, the large surface area of the invention provides more coverage of the tub or sink to which it is applied compared to the prior art. Having read the disclosure, it will then be understood by those having ordinary skill in the art that the larger surface area also provides ample contact for the means of attachment (described in more detail below).

The present disclosure describes the absorbing of kinetic impact energy by use of a durable and resilient deformable material of construction. In some implementations, additional cushions are added to the outer surface of the invention for increased impact protection. The cushions can also enhance the comfort of a person interacting with the tub or sink, such as when a child leans over the edge of a sink, or when an adult sits on the edge of the tub.

### BRIEF DESCRIPTION OF THE SEVERAL VIEWS OF THE DRAWINGS

FIG. 1 shows an orthogonal view of the top of a basic implementation of the invention generally having an elongated central member with multiple arms positioned along the length of the central member.

FIG. 2 shows an orthogonal view of the top of a basic implementation similar to FIG. 1, but with an alternative arrangement of the multiple arms.

FIG. 3 shows an orthogonal view of the top of a basic implementation similar to FIG. 2, but having a wider arm dimension and a narrower gap dimension.

FIG. 4 shows an orthogonal view of the bottom of the same implementation of FIG. 3.

FIG. 5 shows a perspective view of the top of the implementation of FIG. 1, wherein the edge guard is attached to the edge of a generally rectangular tub.

FIG. 5a shows a magnified view of a part of the implementation seen in FIG. 5.

FIG. 5b shows a cross sectional view of the implementation seen in FIG. 5.

FIG. 6 shows a perspective view of the top of the implementation of FIG. 1, wherein the edge guard is attached to the edge of a generally rectangular tub abutted against a vertical wall.

FIG. 6a shows a magnified view of a part of the implementation seen in FIG. 6.

FIG. 6b shows a cross sectional view of the implementation seen in FIG. 6.

FIG. 7 shows a perspective view of the top of the implementation of FIG. 1, wherein the edge guard is attached to the edge of a generally oval shaped tub.

FIG. 8 shows an orthogonal view of the top of a basic implementation similar to FIG. 2, but having generally narrow trapezoidal arms relative to the generally narrow rectangular arms of FIG. 2.

FIG. 9 shows an orthogonal view of the top of a basic implementation similar to FIG. 1, but having a different arrangement of the arms, which are generally wider trapezoidal arms with narrow gap spacing, relative to the generally narrow rectangular arms of FIG. 1.

FIG. 10 shows an orthogonal view of the top of a basic implementation similar to FIG. 9, but having a different arrangement of the arms and having two arms that are longer than the others.

FIG. 11 shows an orthogonal view of the top of a basic implementation similar to FIG. 1, but having a generally wider trapezoidal arms with narrow gap spacing, relative to the generally narrow rectangular arms of FIG. 1, and further comprising a cushion positioned on the central member.

FIG. 12 shows a cross sectional view of the implementation seen in FIG. 11 as positioned on the edge of a tub as in FIG. 5 and FIG. 5b.

FIG. 13 shows an orthogonal view of the top of a basic implementation similar to FIG. 11, but having two cushions where each is positioned partially on the central member and partially on at least one arm.

FIG. 14 shows a cross sectional view of the implementation seen in FIG. 13 as positioned on the edge of a tub as in FIG. 5 and FIG. 5b.

FIG. 15 shows an orthogonal view of the top of a basic implementation similar to FIG. 13, but with arms similar to FIG. 10.

FIG. 16 shows an orthogonal view of the top of a basic implementation similar to FIG. 3, but with a means of connecting positioned on each distal end of the central member.

### DETAILED DESCRIPTION

In the paragraphs below, detailed descriptions of the various exemplifying implementations will be set out. Some of these implementations will correspond to one or more of the drawings (figures). Note that the drawings are meant to illustrate the relative arrangement of features in relation to one another and not necessarily the exact ratio of dimensions. There are many more implementations that do not have a corresponding drawing, both expressly described and implied in this disclosure. Furthermore, the implementations may be referred to as a “bathtub edge guard” but upon reading, it will be readily understood by one having ordinary skill in the art that the device can be used on a number of target surfaces including bathtubs and sinks. The naming should not be understood to limit the application of the various stated, implied, and otherwise disclosed implementations.

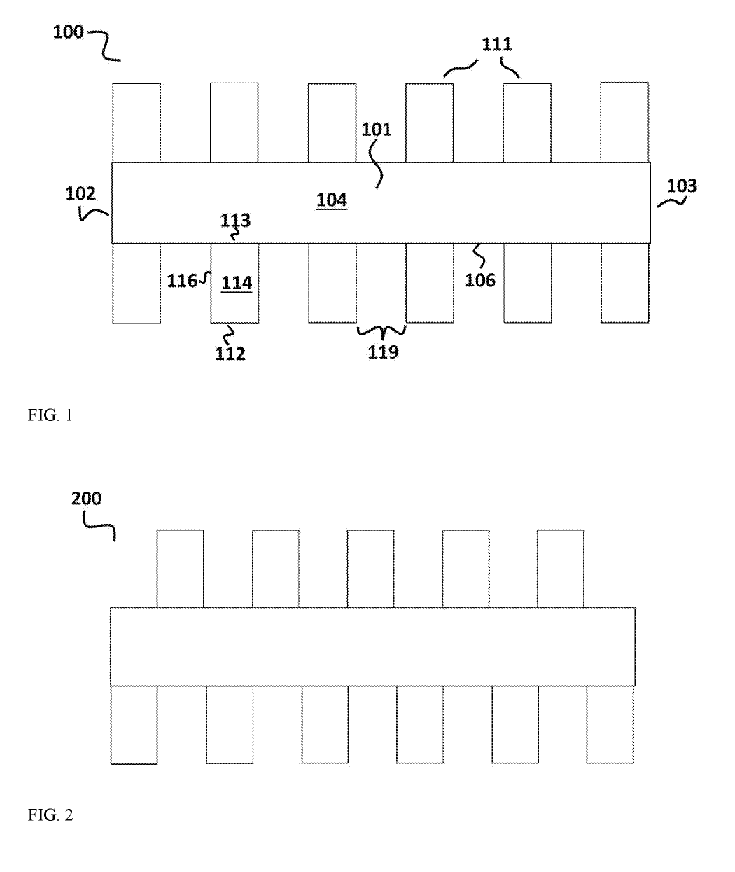

FIG. 1 shows a first and basic implementation of the bathtub edge guard 100 comprising an elongated central member 101 and a multitude of arms 111. The central member 101 has a first member end 102 and a second member end 103 positioned distally. The central member 101 further has a member top surface 104, a member bottom surface 105, and a member perimeter edge surface 106. Each of the multitude of arms 111 has a first arm end 112 and a second arm end 113. Each of the multitude of arms 111 further has an arm top surface 114, an arm bottom surface 115, and an arm perimeter edge surface 116. The multitude of arms 111 are each positioned along the member perimeter edge surface 106.

Further describing the basic implementation shown in FIG. 1, Bathtub Edge Guard 100 has the multitude of arms 111 arranged such that the first arm end 112 of each of the multitude of arms 111 is connected to member perimeter edge surface 106 of the central member 101. Having read the present disclosure, it will be understood by those having ordinary skill in the art that the multitude of arms 111 could be formed into the central member 101. In other words, the central member 101 and the multitude of arms 111 can be joined, connected, fused, or formed monolithically without departing from the present disclosure. Furthermore, the multitude of arms 111 seen in FIG. 1 are arranged as opposing pairs on the central member 101. However, upon reading the present disclosure it will also be understood that there are other possible arrangements of the multitude of arms 111. For example, FIG. 2 shows an alternate implementation, Bathtub Edge Guard 200 having a staggered arrangement of the multitude of arms. Another implementation, not shown in the figures, has the multitude of arms arranged on only one side edge of the central member.

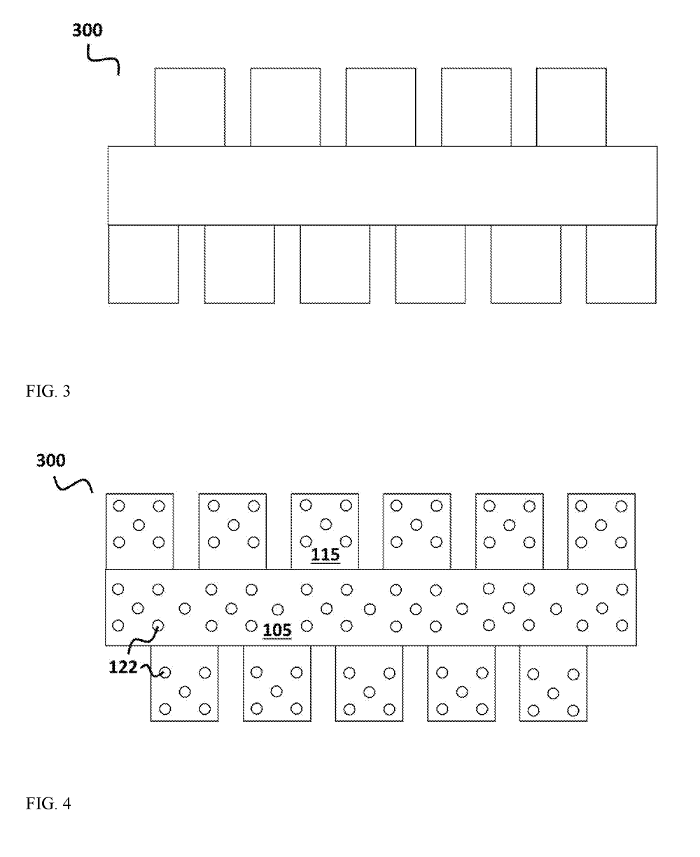

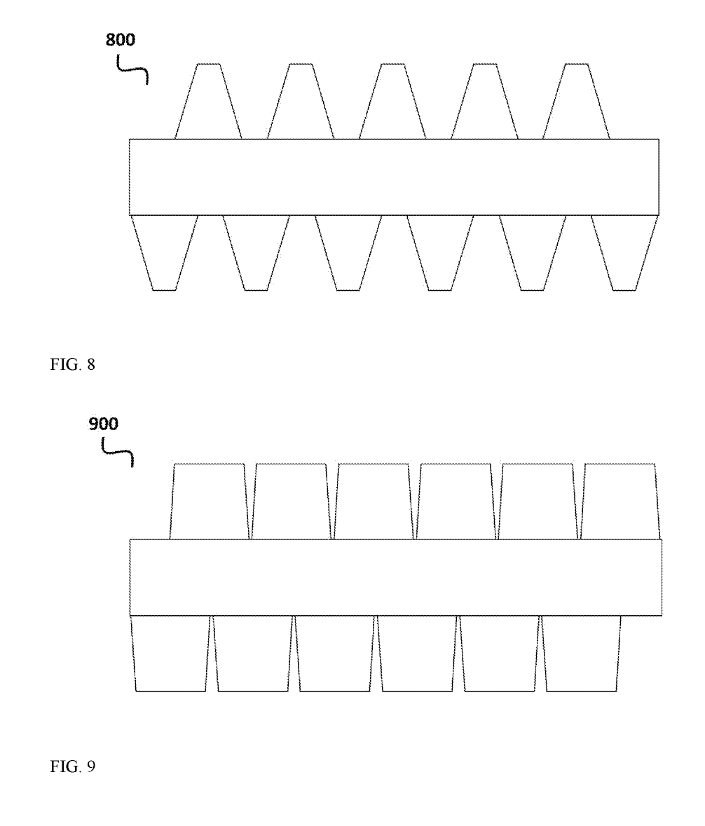

Referring broadly to the various implementations of the present disclosure, each arm of the multitude of arms is positioned such that there is a space, a gap, separating each arm from the arm that is adjacent to it. Turning back to the Bathtub Edge Guard 100 shown in FIG. 1, each arm of the multitude of arms 111 is positioned such that there is a gap 119, separating it from the next adjacent arm. In FIG. 1, the gap 119 has a width dimension that appears substantially equivalent to the width dimension of each arm of the multitude of arms 111. Recall that the drawings are meant to illustrate the relative arrangement of features in relation to one another and not necessarily the exact ratio of dimensions. Therefore, having read the present disclosure, it will be understood by those having ordinary skill in the art that the multitude of arms 111 could be either differently positioned or given dimensions such that gap 119 is not substantially equivalent to the width of each arm. For example, FIG. 3 shows an alternate implementation having a gap that is much smaller relative to the width of each arm of the multitude of arms. Likewise, FIG. 8 and FIG. 9 show two additional implementations, Bathtub Edge Guard 800 and Bathtub Edge Guard 900 respectively, where each arm of the multitude of arms is not generally rectangular as depicted in Bathtub Edge Guard 100, but rather has a substantially trapezoidal shape that causes the gap to widen or taper outward at the second arm end. In fact, having read the disclosure one having ordinary skill in the art will recognize that the arm shape is selectable from a vast group of shapes including many polygons and other shapes. For example, another implementation that is not shown in the drawings features arms of the multitude of arms with a rounded perimeter shape.

The gaps are important because they allow for the ready flexing and conforming of the device to the target surface.

Bathtub edge guard 100 appears in FIG. 1 with a specific ratio of length to width. However, having read the present disclosure it will be understood by those having ordinary skill in the art that the several dimensions of the implementation are readily adjustable to various applications or uses. For example, an implementation that is configured for use on a generally rectangular sink edge having a perimeter of X inches with side wall lengths of A, B, C, and D inches can be made to have a total length less than or equal to X. The configuration of that implementation can be taken one step further by setting the width of each of the multitude of arms and the spacing as a common or regular fraction of the side wall lengths A, B, C, and D. Alternatively, the length, width, height, and other dimensions of the implementation may be set arbitrarily or based on common tub or sink dimensions.

Referring broadly to the various implementations of the present disclosure, the bathtub edge guard further comprises an adhesive means for attaching to the target surface. The adhesive means is essentially a target surface fastener. Turning to FIG. 4, the implementation of FIG. 3 is shown from the bottom rather than from the top. In the implementation of FIG. 4, the adhesive means is a multitude of suction cups 122. However, having read the present disclosure it will be understood by those having ordinary skill in the art that the adhesive means could be selected from a group including but not limited to magnets, glue, epoxy, hook and loop fastener strips, tape, or thin sticky films applied directly to the surfaces. Another aspect that will be understood upon reading the present disclosure is that the adhesive means, such as the suction cups 122 of the implementation shown in FIG. 4, could be positioned on only the multitude of arms rather than on both the multitude of arms and the central member. Another aspect that will be understood upon reading the present disclosure is that the adhesive means, such as the suction cups 122 of the implementation shown in FIG. 4, could be spaced in different densities than appear in FIG. 4, relative to the surface areas of the central member bottom surface and the arm bottom surface. In other words, there could be more or fewer points of contact. A preferred implementation has sufficient adhesive means to achieve a bond to the target surface (such as a sink or tub) that will support the total weight of the implementation and withstand expected interaction forces of ordinary use of the target surface.

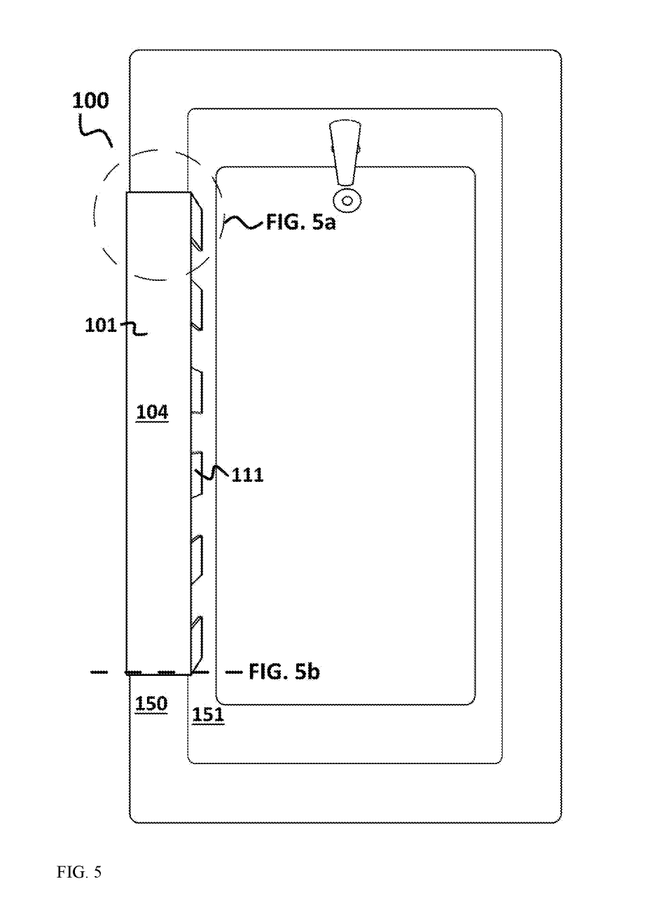

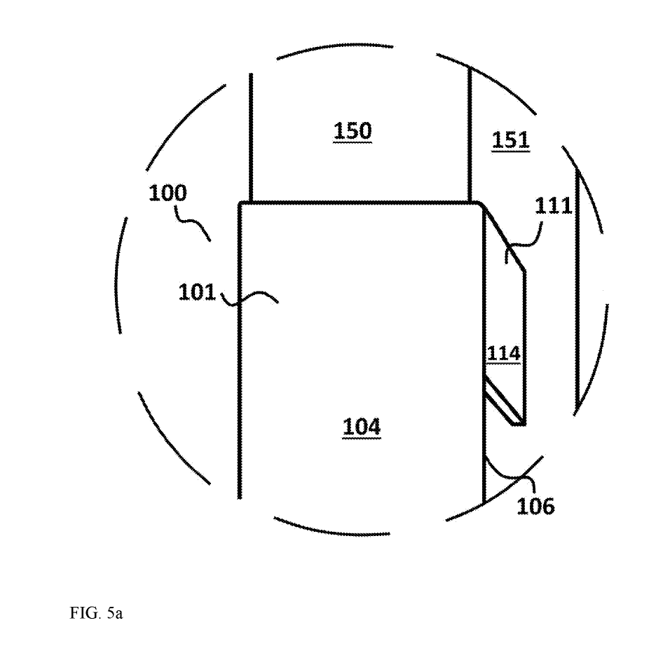

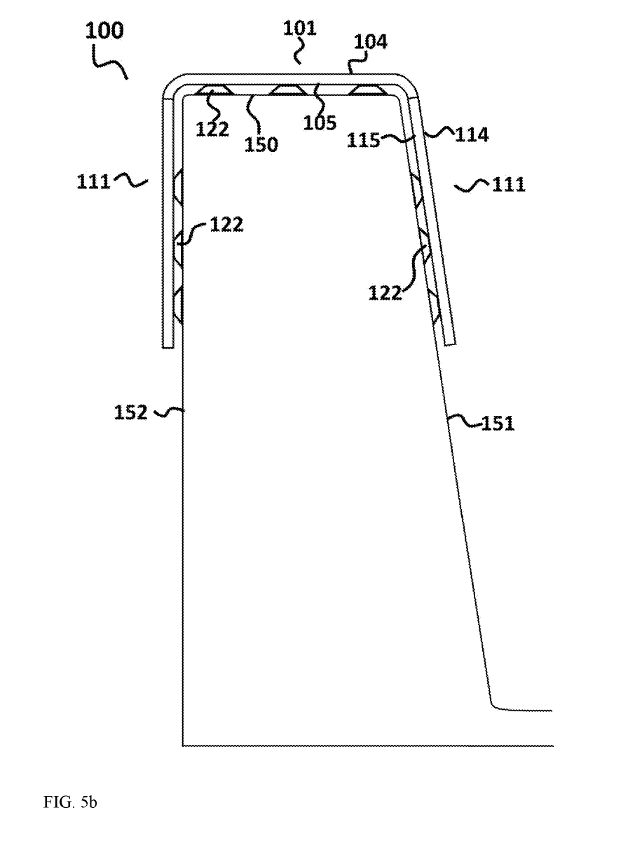

FIG. 5 shows the bathtub edge guard 100 in use, (attached to) on the relatively straight side wall edge of a generic rectangular shaped bathtub. The central member 101 generally lies across the bathtub sidewall top edge 150 though it may partially extend along the bathtub sidewall inner edge 151 and bathtub sidewall outer edge 152 depending on the width of the tub sidewall and the width of the central member. The multitude of arms 111 generally extend downward along the bathtub sidewall inner and outer edges, 151 and 152 respectively, though the arms may partially extend across the bathtub sidewall top edge 150 depending on the width of the tub sidewall and the width of the central member. FIG. 5a shows a magnified portion of FIG. 5, for clarity. FIG. 5b shows a cross section view of the bathtub edge guard 100 in use on the generic bathtub of FIG. 5.

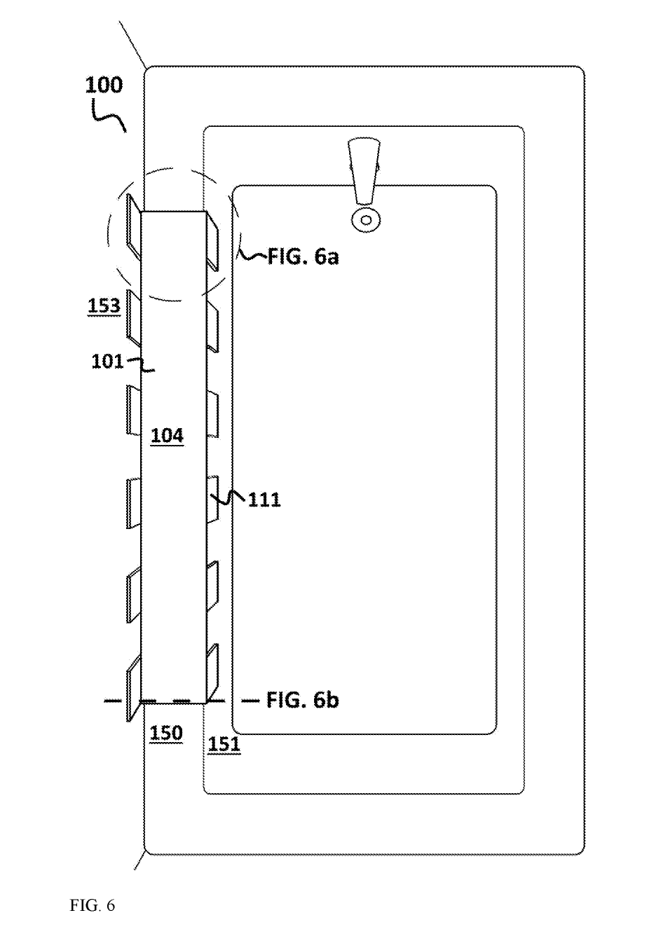

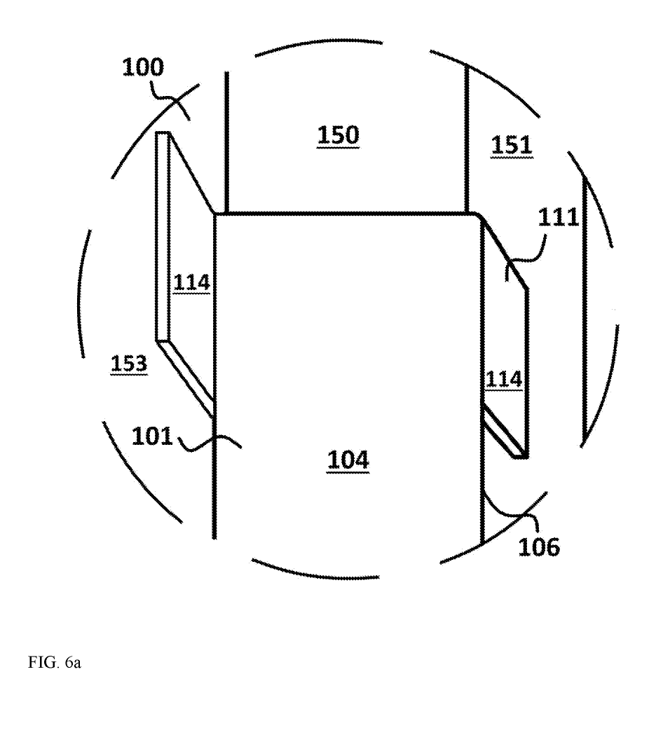

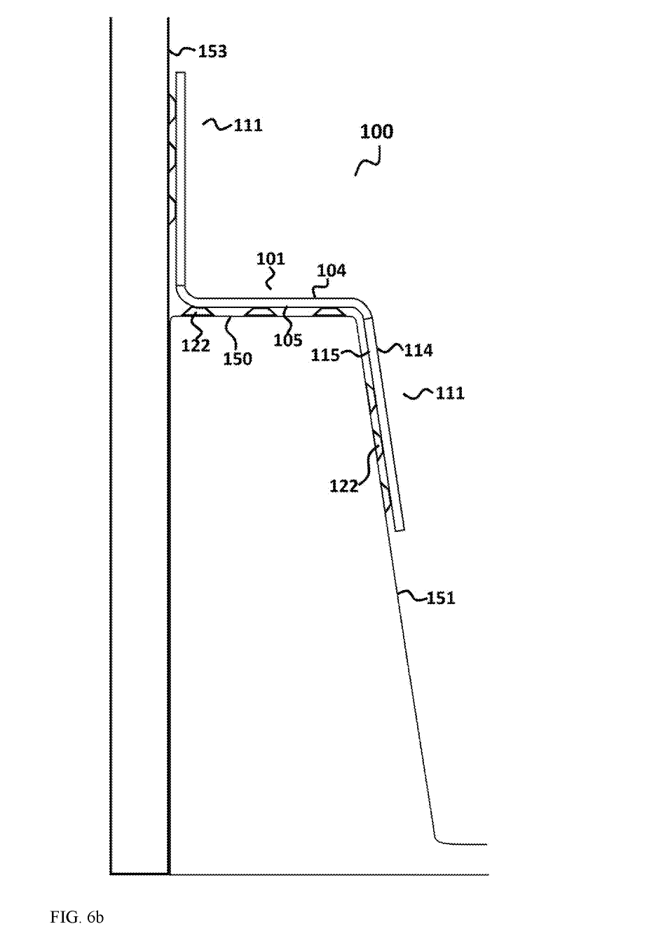

Another important feature of the present invention is shown in FIG. 6. FIG. 6 shows the same Bathtub Edge Guard 100 as applied to a generic tub similar to that of FIG. 5, except that the tub of FIG. 6 does not have a bathtub sidewall outer edge 152 on the side of the tub where the Bathtub Edge Guard 100 has been positioned. Instead, there is a vertical wall 153 that abuts the bathtub. The multitude of arms 111 that extend towards the wall 153 engage with and attach to wall 153. This demonstrates the adaptability and flexibility of the disclosed implementations.

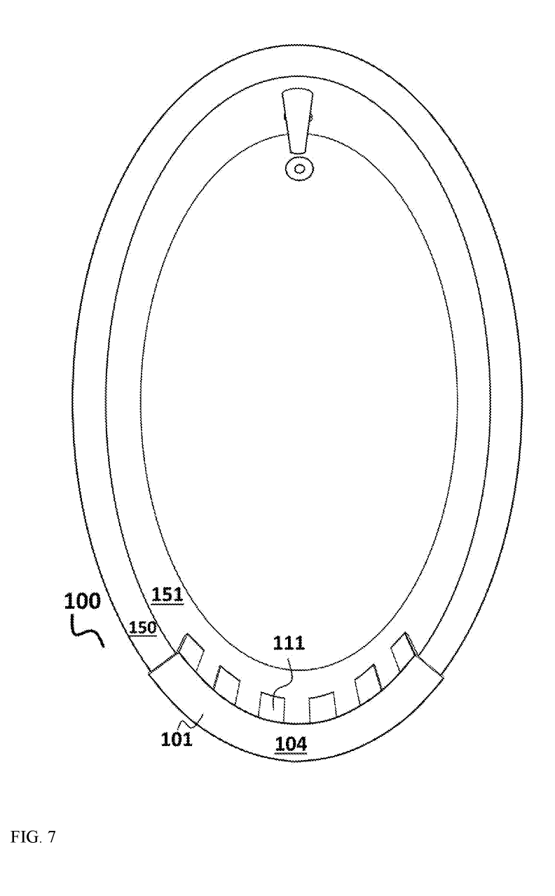

FIG. 7 shows the Bathtub Edge Guard 100 in use, (attached to) on the curving sidewall edge of a generic oval shaped bathtub. Note the ability of the central member 101 to conform to and adapt to the curvature of the sidewall.

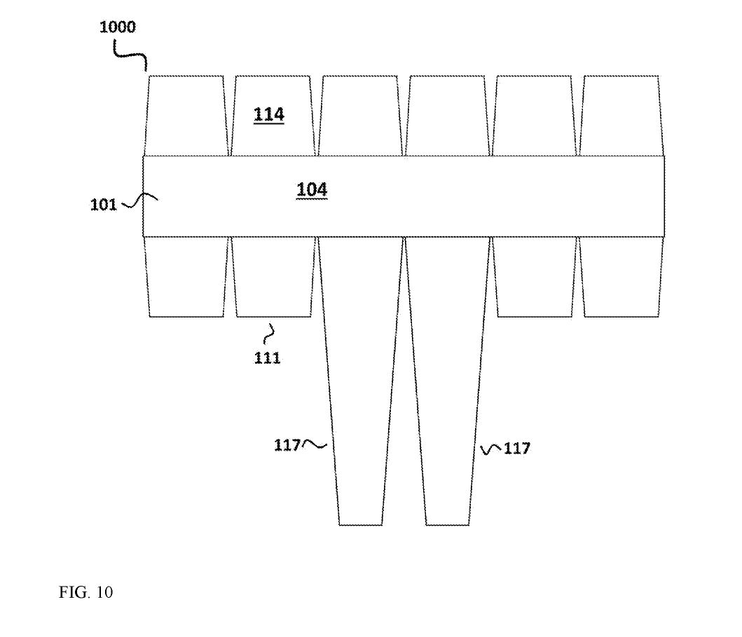

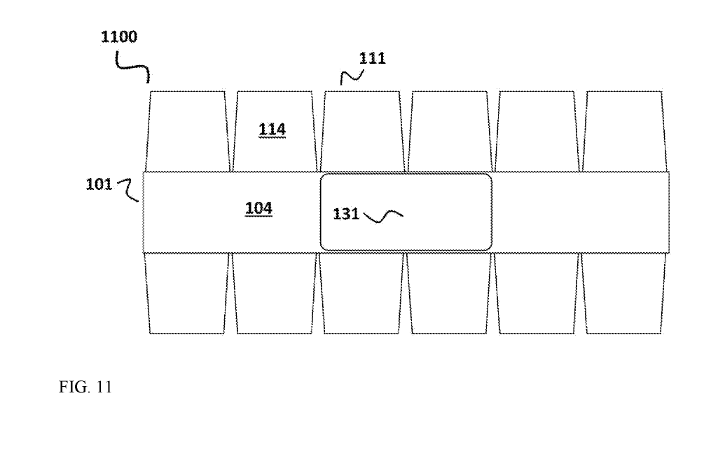

Thus far, only implementations having a multitude of arms wherein each arm was identical to the others have been shown in the figures. However, there is no requirement that the arms all be identically dimensioned. In some implementations, it is preferable to have one or more arms with different dimensions compared to the other arms. See Bathtub Edge Guard 1000 in FIG. 10. Bathtub Edge Guard 1000 has two adjacent and centrally located elongated arms 117 among the multitude of arms 111 that have a greater respective length relative to the other arms. There are a number of reasons why this is desirable in certain implementations. These elongated arms 117 may be desired for increased surface area coverage to further enhance the protection. One possible use could be for increased coverage of the bathtub inner sidewall edge that is sloped (the wall that is essentially used as a back-rest). The padding that the bathtub edge guard would provide would therefore both enhance the safety in an unexpected collision and also enhance the user's comfort during regular tub use.

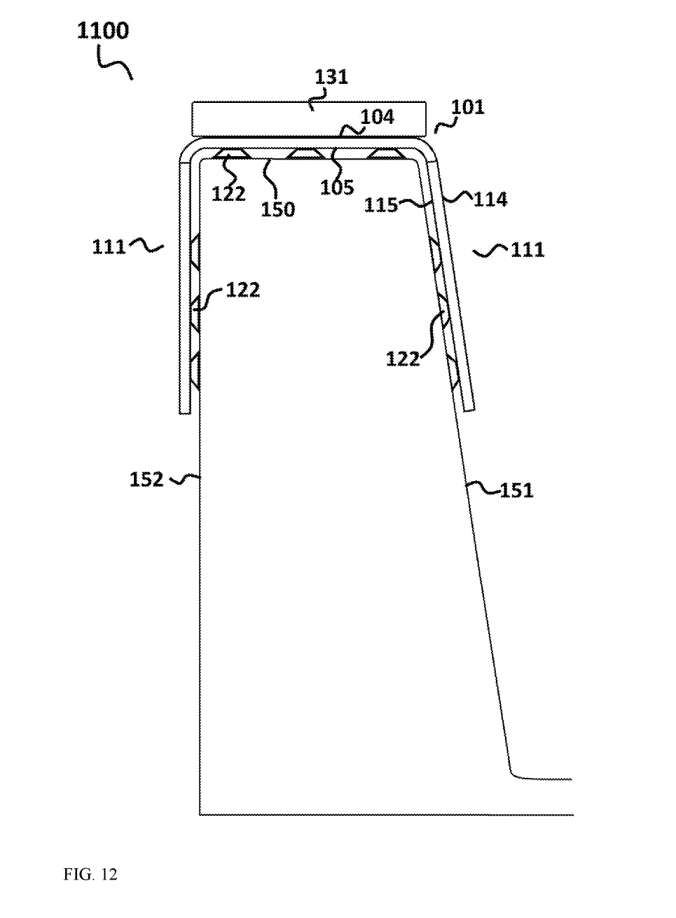

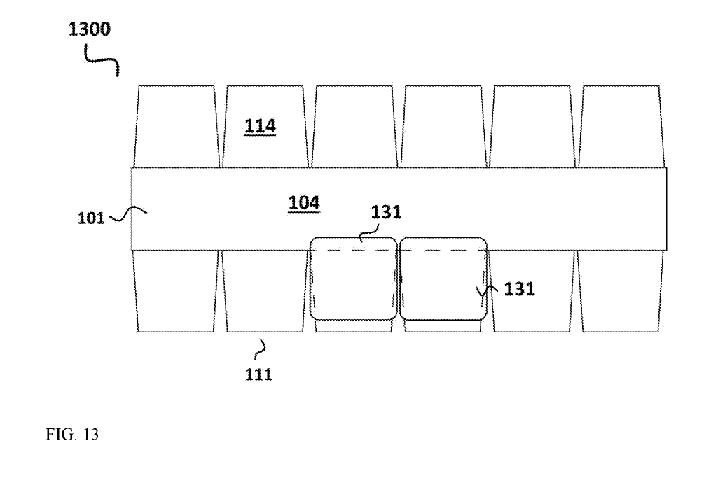

Other implementations of the bathtub edge guard further comprise at least one cushion. The cushion of the at least one cushion further increases the protection to the user in an unexpected collision because it increases the overall energy the bathtub edge guard can absorb or dissipate. The cushion further adds to the overall comfort during regular interactions with the target surface. For example, see Bathtub Edge Guard 1100, shown in FIG. 11 and FIG. 12, there is at least one cushion 131 that is positioned above the central member 101, attaching to the member top surface 104. FIG. 12 is the cross section view of the same implementation of FIG. 11 as applied to the side wall of a generic bathtub as seen and described in FIG. 5. The central member 101 generally lies across the bathtub sidewall top edge 150 though it may partially extend along the bathtub sidewall inner edge 151 and bathtub sidewall outer edge 152 depending on the width of the tub sidewall and the width of the central member. The multitude of arms 111 generally extend downward along the bathtub sidewall inner and outer edges, 151 and 152 respectively, though the arms may partially extend across the bathtub sidewall top edge 150 depending on the width of the tub sidewall and the width of the central member. The cushion 131 of FIG. 11 and FIG. 12 has dimensions such that its width is substantially equivalent to the width of the central member 101.

Having read the present disclosure, it will be understood by those having ordinary skill in the art that the at least one cushion could be either differently positioned or given dimensions such that it is not substantially equivalent to the width of the central member. For example, FIG. 13 shows an alternate implementation, Bathtub Edge Guard 1300, having two cushions 131, where each of the cushions is partially positioned above the central member 101 and partially positioned above an arm of the multitude of arms 111.

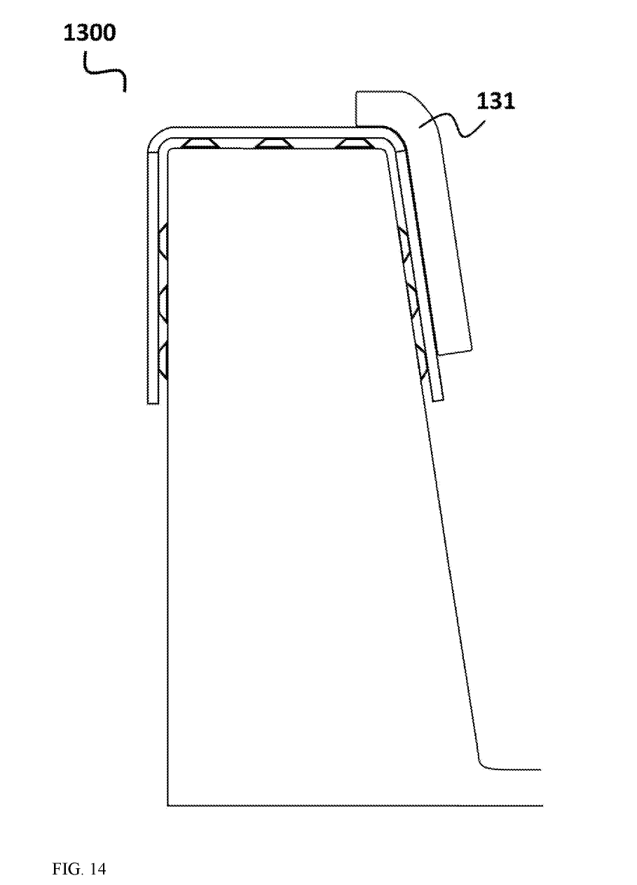

FIG. 14 shows the cross section view of the Bathtub Edge Guard 1300 of FIG. 13 as applied to a generic bathtub sidewall similar to the tub described in FIG. 5. Here again as in FIG. 5, the central member 101 generally lies across the bathtub sidewall top edge 150 though it may partially extend along the bathtub sidewall inner edge 151 and bathtub sidewall outer edge 152 depending on the width of the tub sidewall and the width of the central member. The multitude of arms 111 generally extend downward along the bathtub sidewall inner and outer edges, 151 and 152 respectively, though the arms may partially extend across the bathtub sidewall top edge 150 depending on the width of the tub sidewall and the width of the central member.

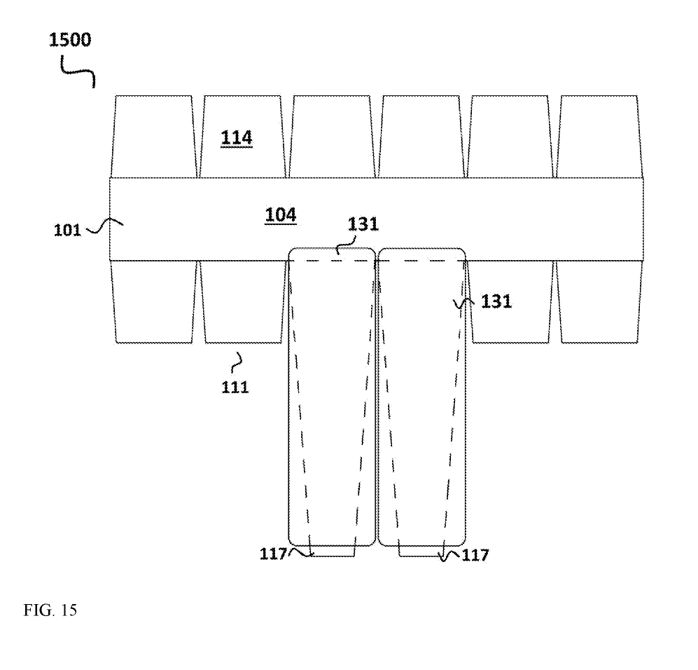

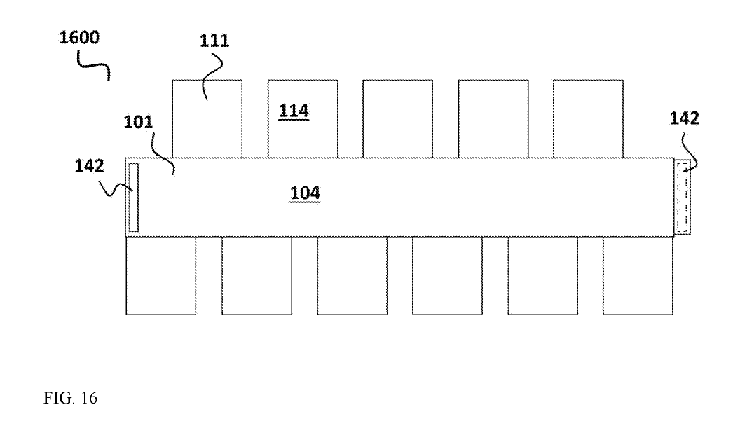

FIG. 15 shows another implementation, Bathtub Edge Guard 1500, having two cushions 131 where each of the cushions is partially positioned above the central member 101 and partially positioned above an elongated arm 117 of the multitude of arms 111. In another implementation, not shown in the figures, the at least one cushion is positioned partially over at least two arms of the multitude of arms.

The at least one cushion of the present disclosure may be attached using one or more of a variety of known attachment methods. For example, a matching pair of hook and loop patches may be used on the bottom surface of the at least one cushion and the member top surface 104. Having read the present disclosure it is understood by one having ordinary skill in the art that there are many other attachment methods such as using sewing, magnets, buttons, clasps, tie straps, tie strings, loop and toggles, interlocking tabs, tape, or thin sticky films whether applied directly to the surfaces or embedded.

In some applications, the user may desire to join more than one bathtub edge guard together. Thus in some implementations, the bathtub edge guard further comprises a means for connection, via a connector 141, on at least one of either the first member end 102 or the second member end 103. For example, see Bathtub Edge Guard 1600 of FIG. 16. In that implementation, the connector is a pair of corresponding strips of hook and loop fastener. However, having read the present disclosure it will be understood by those having ordinary skill in the art that the connection means could be selected from a group including but not limited to buttons, clasps, loop and toggles, interlocking tabs, tie strings, tie straps, magnets, hook and loop fastener strips, tape, or thin sticky films whether applied directly to the surfaces or embedded.

Having read the present disclosure, many materials of construction will be understood to be suitable, though not necessarily equivalent. Given the expected high moisture environments, materials that are mold and mildew resistant will be advantageous. Of course the material must be resiliently deformable to provide for the impact energy absorption and dissipation, thus materials having these properties will be preferred. Some examples of the preferred materials include rubber, rubberized silicone, silicone, styrene foam, neoprene, and foamed neoprene. Another suitable class includes non-Newtonian liquid compositions. Another concern is that the implementation adheres to the target surface. The preferred examples above lend themselves well to forming suction cups or embedding surface fasteners or being easily contained in flexible cases, bags, or sleeves that can perform the same.

In some implementations, the member top surface of the bathtub edge guard further comprises a means for enhanced friction, a friction enhancer. In some implementations, the friction enhancer is a friction increasing surface texture that is formed into the member top surface. Other means for enhancing the friction of the member top surface will be understood by those having ordinary skill in the art.

In some implementations, the central member has a width that is selected from within the range of half an inch to eight (0.5-8) inches. In some implementations the width of each arm of the multitude of arms is selected from within the range of one to twelve (1-12) inches, and the length of each is selected from the range of one to twenty four (1-24) inches.

Although the invention has been described and illustrated with a certain degree of detail or with reference to one or more particular implementations, it is understood that the present disclosures have been made only by way of example. It should be understood that the invention is not intended to be limited to the particular forms disclosed. Furthermore, the invention is amenable to various modifications and alternative forms. Obvious variations and other various changes in the composition, combination, and arrangement of parts can be utilized to by those skilled in the art without departing from the spirit and scope of the invention, as herein disclosed and claimed.

1. An edge guard for a target surface comprising:
a central member, comprising a member top surface, a member bottom surface, and a member perimeter edge surface;
a multitude of arms, each arm of the multitude of arms comprising an arm top surface, an arm bottom surface, and an arm perimeter edge surface, said multitude of arms positioned along the member perimeter edge surface of the central member such that a gap separates adjacent arms; and
at least one target surface fastener.

2. The edge guard of claim 1 wherein at least one of the at least one target surface fastener is positioned on the arm bottom surface of each arm of the multitude of arms.

3. The edge guard of claim 1 wherein the at least one target surface fastener comprises a multitude of target surface fasteners positioned on the arm bottom surface of each arm of the multitude of arms and on the member bottom surface of the central member.

4. The edge guard of claim 3 wherein each of the multitude of target surface fasteners is selected from the following group: magnets, adhesive film, and suction cups.

5. The edge guard of claim 3 wherein each of the multitude of target surface fasteners is comprised of a suction cup.

6. The edge guard of claim 1 wherein the multitude of arms further comprises at least one elongated arm.

7. The edge guard of claim 1 further comprising at least one cushion.

8. The edge guard of claim 7 wherein the at least one cushion is positioned at least partially on the member top surface of the central member.

9. The edge guard of claim 7 wherein the at least one cushion is positioned at least partially on the arm top surface of at least one of the multitude of arms.

10. The edge guard of claim 7 wherein the at least one cushion is attached by selecting one of the following fastening methods: hook and loop patches, sewing, magnets, buttons, clasps, tie straps, tie strings, loop and toggles, interlocking tabs, tape, or thin sticky films.

11. The edge guard of claim 1 wherein the multitude of arms are arranged in opposing pairs along the member perimeter edge surface of the central member.

12. The edge guard of claim 1 wherein the multitude of arms are arranged in a staggered pattern along the member perimeter edge surface of the central member.

13. The edge guard of claim 1 wherein the materials of construction are selected from the group comprising: rubber, rubberized silicone, silicone, foam, neoprene, foamed neoprene, and non-Newtonian liquids.

14. The edge guard of claim 1 further comprising a pair of corresponding connectors, comprising a first part and a second part, where the first part of the pair is positioned on a first member end of the central member and the second part is positioned on a second member end of the central member that is distal to the first member end.

15. The edge guard of claim 14 wherein the pair of corresponding connectors is comprised of a corresponding paired strip of hook and loop fastener material.

16. The edge guard of claim 1 further comprising a friction enhancer.

17. The edge guard of claim 16 wherein the friction enhancer is comprised of a surface texture formed into the member top surface of the central member.

18. The edge guard of claim 1 wherein the central member has a width that is selected from within the range of half an inch to eight inches.

19. The edge guard of claim 1 wherein each arm of the multitude of arms has a width that is selected from within the range of one inches to twelve inches, and the length of each arm is selected from the range of one inch to twenty four inches.
